(19) United States
(12) Patent Application Publication
(10) Pub. No.: US 2017/0151872 A1
(43) Pub. Date: Jun. 1, 2017

(54) A VEHICLE DRIVELINE SYSTEM

(71) Applicant: BorgWarner TorqTransfer Systems AB, Landskrona (SE)

(72) Inventors: KRISTOFFER NILSSON, Lund (SE); HENRIK NILSSON, Eslöv (SE)

(73) Assignee: BorgWarner TorqTransfer Systems AB, Landskrona (SE)

(21) Appl. No.: 15/322,485

(22) PCT Filed: Jul. 2, 2015
(86) PCT No.: PCT/EP2015/065167

§ 371 Date: Dec. 28, 2016

(30) Foreign Application Priority Data
Jul. 2, 2014 (SE) 1450830-3

(51) Int. Cl. B60K 17/346; B60K 23/08; F16H 37/08

(52) U.S. Cl. CPC B60K 17/346; F16H 37/0813; B60K 23/08; F16H 48/08

(57) ABSTRACT

A vehicle driveline system (100) is provided comprising a differential (120) having an input (102), a front output (106) connecting to a front axle (12) and a rear output (104) connecting to a rear axle (14). The vehicle driveline system (100) further comprises an actuator (130) which is configured to control the operation of the differential (120) between a first mode, in which the front output (106) is disconnected from the input (102), and a second mode, in which the front output (106) is connected to the input (102).

### TECHNICAL FIELD

The present invention relates to a vehicle driveline system. More particularly, the present invention relates to a vehicle driveline system having a transfer case.

### BACKGROUND

There is an increasing demand to reduce CO2 emissions from passenger vehicles due to stricter legislation in most parts of the world. These increasing demands for loss reduction in combination with demand for increased functionality and lower cost creates a need for new driveline technology. Today more and more vehicles are equipped with driveline disconnect systems to reduce the losses of the AWD-System. The drawback of these systems are that they tend to come with a high cost and that the loss in the disconnected (2WD)-mode is not fully optimized, mainly because of the high clutch drag.

Also motivated by the CO2 legislation more and more vehicles are and will be equipped with mild hybridization by for example a small 48 V electrical motor installed as an belt-integrated starter generator (B-ISG) on the engine. Although the B-ISG gives a very good reduction in CO2 it does not fully utilize the reduction potential of a small electrical motor in the vehicle. For example, while regenerating the engine must be rotating since the B-ISG is directly connected to it, thus resulting in additional losses. Also the used of an electrical motor as B-ISG creates limited additional functionality to the vehicle.

In view of this there is a need for an improved vehicle driveline system.

### SUMMARY

An object of the present invention is to provide a vehicle driveline system overcoming the drawbacks of prior art system.

According to a specific aspect a vehicle driveline system according to the independent claim is provided. Preferred embodiments are defined by the appended dependent claims.

### BRIEF DESCRIPTION OF DRAWINGS

The invention will be described in further detail under reference to the accompanying drawings in which:

FIG. 1 is a schematic view of a vehicle driveline system according to an embodiment;

FIG. 2 is a schematic view of the vehicle driveline system shown in FIG. 1, however operated in a mode in which the front axle is disconnected;

FIG. 3 is a schematic view of a differential according to an embodiment;

FIG. 4 is a cross sectional view of the differential shown in FIG. 3, however operated in a disconnect mode;

FIG. 5 is a cross sectional view of a differential according to an embodiment;

FIG. 6 is a cross sectional view of the differential shown in FIG. 3, however operated in a disconnect mode;

FIG. 7 is a schematic view of a vehicle driveline system according to a further embodiment; and

FIG. 8 is a schematic view of a vehicle driveline system according to a yet further embodiment.

### DETAILED DESCRIPTION

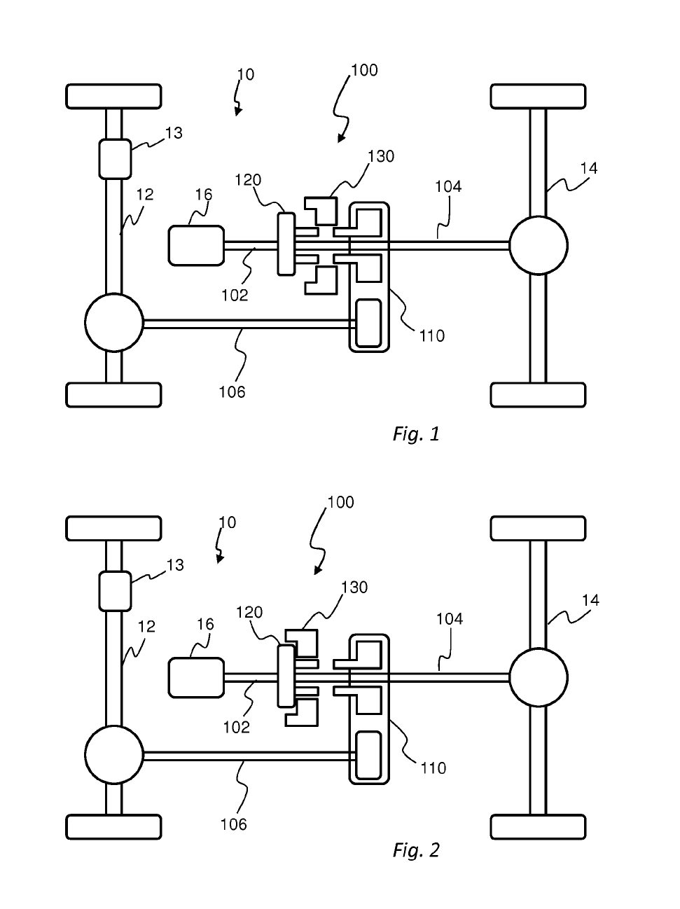

In FIG. 1 a vehicle driveline system 100 in the form of a transfer case is shown. The transfer case 100 is arranged in a vehicle 10 having a front axle 12, a rear axle 14, and an engine 16 for driving the transfer case 100 via a transmission (not shown).

The transfer case 100 has an input shaft 102 being connected to the engine 16, a rear output shaft 104, and a front output shaft 106. The front output shaft 106 is arranged non-coaxially relative the rear output shaft 104; the front output shaft 106 is connected to the input shaft 102 via a chain drive 110. Input torque is transmitted to a center differential 120, having a first output being the rear output shaft 104, and a second output being a driving side of the chain drive 110 thus connecting to the front output shaft 106. The front output shaft 106 is driving the front axle 12, while the rear output shaft 104 is driving the rear axle 14.

By using a center differential 120 with a torque distribution of for example 50/50 or 60/40 a good and robust AWD-system can be achieved. Normally the center differential topology cannot be combined with disconnect since disconnecting one shaft 104, 106 from the differential 120 will mean that there will be no torque transfer to any of the output shafts 104, 106. By combining an already existing disconnect 13 of for example the front axle 12 with a mechanical lock of the differential 120 the torque transfer to the other (in this case the rear) axle can be maintained. Since the described system 100 does not have a clutch, the drag losses will be very low in the disconnected mode. An actuator 130 is provided for controlling the operation of the differential 120. The actuator 130 may e.g. be a shifting sleeve, an electro-magnetic actuator, or an electro-magnetic actuator.

The cost of the shifting sleeve 130 providing the connect/disconnect function will be lower than a clutch pack. Also the actuation of the shifting sleeve 130 between connected position and disconnected position can be done by a simpler actuation system and at lower cost than the clutch actuation system. The shifting sleeve 130 can also be designed to lock the differential 120 before disconnecting the front axle 12, thus creating a third state with AWD and locked differential 120 suitable for heavy off-road conditions.

In FIG. 1 the actuator 130, being realized as a shifting sleeve, is arranged in a connect mode connecting the front output of the differential 120 with the front axle 12. Hence, input torque from the engine 16 will be transferred to the front axle 12 as well as to the rear axle 14.

In FIG. 2 the shifting sleeve has moved in order to disconnect the front output of the differential 120 from the front axle 12. Hence, input torque will be transferred to the rear axle 14 only.

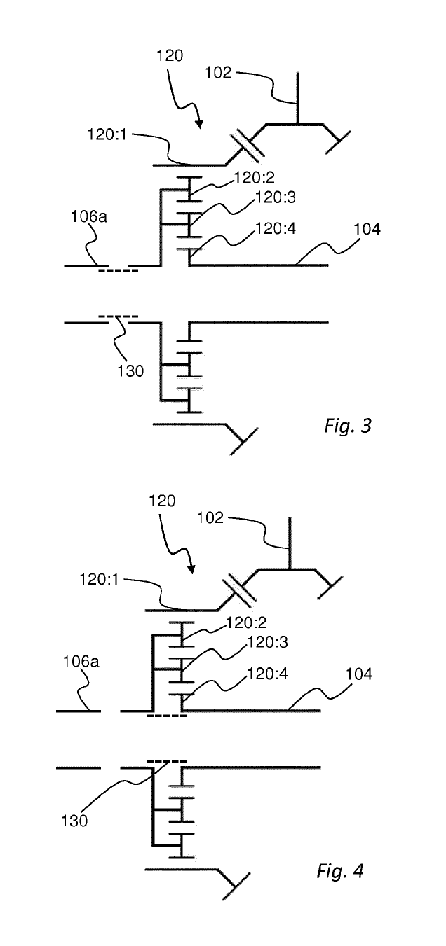

FIGS. 3-4 show an embodiment of a differential 120 for use with the driveline system 100 of FIGS. 1-2. The differential can for example be of bevel gear type as shown or of planetary type.

In FIGS. 3 and 4, the differential is embodied as a planetary type differential having an input shaft 102 driving a ring gear 120:1. The ring gear 120:1 meshes with an outer planet carrier 120:2 in fixed rotational connection with an inner planet carrier 120:3. The inner planet carrier 120:3 meshes with a sun gear 120:4 being connected with a rear output 104, while the planet carriers 120:2, 120:3 are in driving connection with the front output 106a. An actuator 130, e.g. in the form of a shifting sleeve, is arranged to mechanically lock the rear output 104, i.e. the planet carriers 120:2, 120:3 to the front output 106a, i.e. the sun gear 120:4. In the normal operation, as is shown in FIG. 3, the actuator 130 is connecting the front output 106a with the planet carriers 120:2, 120:3. In this state, the differential 120 is open such that driving torque is provided to the front and rear axles.

In FIG. 4 a disconnected state is shown, in which the actuator 130 has been actuated to move for locking the differential 120. In this position the planet carriers 120:2, 120:3 are mechanically locked to the sun gear 120:4. At the same time the front output 106a is disconnected from the planet carriers 120:2, 120:3. If the front axle 106a is disconnected, driving torque will still be provided to the rear axle 104.

Upon a desired normal operation of the differential 120, an unlocked state is commanded as shown in FIG. 3. Here the actuator 130 is controlled to unlock the planet carriers 120:2, 120:3 from the ring gear 120:1 and at the same time connect the front output 106a to the planet carriers 120:2, 120:3. In this state, driving torque is provided to the front output as well as to the rear output.

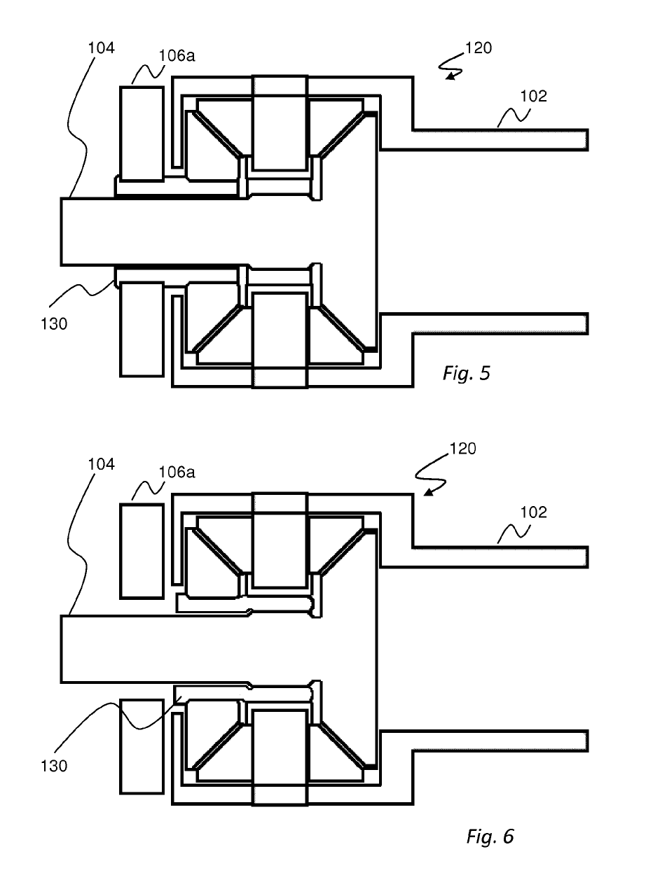

In FIGS. 5 and 6 another embodiment of a differential is shown. The differential 120 has an input 102 for receiving input torque from the engine 16, and two outputs 104, 106a. The rear output 104 connects with the rear axle 14 as shown in FIG. 1, while the front output 106a forms a driving axle for the chain drive 110. FIG. 3 shows an operation mode in which the shifting sleeve 130 is connected to the front output 106a, i.e. the operation mode of FIG. 1. FIG. 4 shows an operation mode in which the shifting sleeve 130 is disconnected from the front output shaft 106a, i.e. the operation mode of FIG. 2.

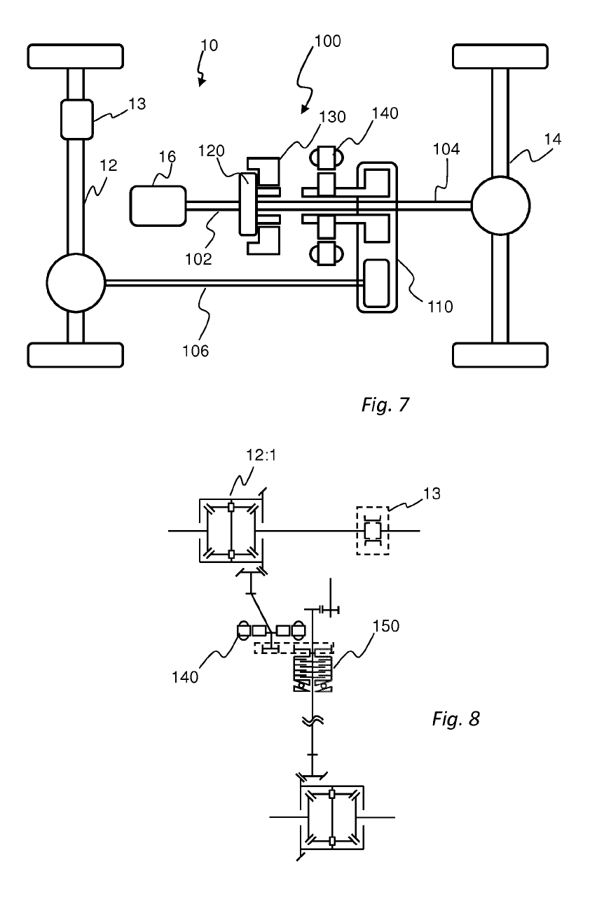

Now turning to FIG. 7 a further embodiment of a vehicle driveline system 100 in the form of a transfer case is shown. By installing an electrical motor 140 in the transfer case, preferably operating on 48V, and connect it to for example the chain sprocket of the chain drive 110, and thus the front axle output shaft 106, additional functionality can be created and losses can be reduced by using the motor 140 for hybrid functions. In fully disconnected mode the driveline and the electrical motor 140 will be stationary resulting in very low losses. In the need of regeneration the front axle dog clutch 13 can be connected and the electrical motor 140 can be used for regeneration. In the event of driving in disconnected 2WD-mode the electrical motor 140 can be used to accelerate the stationary front driveline 106, 12 and achieve fast AWD by applying torque to the front axle 12 with the electrical motor 140. By connecting the front axle dog clutch 13 the system can also be used for electrical driving at low speeds by applying torque with the electrical motor 140.

Now turning to FIG. 8 another embodiment of a vehicle driveline system 100 is shown. The vehicle driveline system 100 forms a transfer case. An engine/transmission 16 drives an input 102 to the transfer case, and a rear output 104 is connected to a rear axle 14. A front output 106a is connected to the front axle 12 via a chain drive 110 of the transfer case 100. The front axle 12 is provided with a disconnect 13. FIG. 8 differs from the previous embodiments in that the transfer case is provided with a clutch 150, replacing the differential 120 of the previous embodiments. By installing an electrical motor 140 in the front driveline 106 in a disconnect system with a clutch topology, the benefits as described above with reference to FIG. 7 can be achieved, but also the electrical motor 140 can be used to synchronize the speed of the front driveline 106 with the rest of the driveline. Since the torque control of the electrical motor 140 is better than the torque control of a clutch the connection sequence can be made faster and with lower risk for noise vibration and harshness (NVH). Also since the electrical motor 140 will take over the synchronization work for the clutch at a connect sequence, the requirements on speed and torque accuracy of the clutch actuation system will be lower, resulting in a lower cost. If for example the clutch actuation system has dual piston areas and a solenoid valve to improve speed and accuracy, these can be removed.

The electrical motor 140 is preferably arranged between the front axle differential 12:1 and the clutch 150. By such configuration there is no need for additional shafts to pass the oil-filled area formed by the clutch 150 and the chain drive 110. This in turns result in a less number of radial seals and reduced losses. By arranging the electrical motor 140 in this position a greater design freedom is also provided, with less impact on packing and driveline design.

Although the present invention has been described above with reference to specific embodiments, it is not intended to be limited to the specific form set forth herein. Rather, the invention is limited only by the accompanying claims.

1. A vehicle driveline system, comprising a differential having an input, a front output connecting to a front axle and a rear output connecting to a rear axle, wherein said vehicle driveline system further comprises an actuator which is configured to control the operation of the differential between a first mode, in which the front output is disconnected from the input, and a second mode, in which the front output is connected to the input.

2. The vehicle driveline system according to claim 1, wherein the actuator is further configured to control the operation of the differential in a third mode, in which the differential is locked and in which the front output is connected to the input.

3. The vehicle driveline system according to claim 1, wherein said actuator is a shifting sleeve.

4. The vehicle driveline system according to claim 3, wherein the shifting sleeve is arranged coaxially around the rear output.

5. The vehicle driveline system according to claim 1, further comprising an electrical motor which is in driving connection with the front output.

6. The vehicle driveline system according to claim 1, wherein the driveline system forms a transfer case and wherein the front output is a shaft for driving the front axle via a chain drive, and the rear output is a shaft for driving the rear axle.

7. The vehicle driveline system according to claim 1, wherein the differential is a bevel-gear differential.

8. The vehicle driveline system according to claim 1, wherein the differential is a planetary gear differential, wherein a ring gear, a planet carrier, and a sun gear form the differential input, the front output and the rear output in any order.

9. A vehicle driveline system for providing all wheel drive, comprising a clutch having a drive side connected to one of the front axle or the rear axle of the vehicle, and a driven side connected to the other one of the front or the rear axle, whereby driving torque will be transferred to the driven side upon actuation of the clutch, wherein said vehicle driveline system further comprises a disconnect arranged on the driven side of the clutch, and an electrical motor arranged between the clutch and a front axle differential, which is in driving connection with the driven side of the clutch.
